(19) United States
(12) Patent Application Publication
(10) Pub. No.: US 2021/0381427 A1
(43) Pub. Date: Dec. 9, 2021

(54) OPPOSED PISTON HYDROGEN ENGINE AND METHOD FOR OPERATION

(71) Applicant: Wojclech Gaj-Jablonski, Oakville (CA)

(72) Inventor: Wojclech Gaj-Jablonski, Oakville (CA)

(21) Appl. No.: 17/286,185

(22) PCT Filed: Oct. 17, 2018
(86) PCT No.: PCT/PL2018/000099

§ 371 Date: Apr. 16, 2021

(51) Int. Cl. F02B 75/24; F02B 33/40; F02B 43/10; B64C 27/12

(52) U.S. Cl. CPC F02B 75/24; F02B 33/40; F02B 2201/04; B64C 27/12; F02B 43/10

(57) ABSTRACT

The system comprises an opposed piston engine. The pistons (1) consist of a top piston half (1a), a spring (1b) and a bottom piston half (1c). The cylinders (3) have inlet channels (8) for compressed air as well as outlet channels (10). fuel injector (12), steam injector (13) and ignition clement (14). A bipartite crankshaft (15) is fitted with exit shafts (19a, 19b) connected with impellers (22) via clutches (20a, 20b). Rotor rims (26) around the impellers contain magnetic dipoles (28), whereas stator rims (27) have induction coils (29). One method concerns using of resilience of a spring situated between two halves of the piston, furthermore piston halves are cooled by a spurt of compressed air. Another method concerns transferring some part of energy of the impeller to the system of collecting and transferring energy attached to it, from which energy is taken in case of an insufficient torque on the impeller shaft.

The object of the present invention is a hybrid propulsion system with an engine especially for hydrogen fuel and a method of protecting a piston of this engine from effects of detonation combustion as well as a method of obtaining a periodical additional torque on an impeller shaft in particular with regard to helicopters powered by this engine.

The hydrogen engine, known from the publication of invention No. WO 2017/039464 of the PCT application, comprises one pair of two-chamber cylinders attached to an engine case, whose inner surface is covered with diamond coating, and double reciprocating pistons situated therein, while cylinders together with pistons are directed opposite each other by the 180° C. angle in the axis of rotation of a bipartite crankshaft which conjugates them, and which is situated in the engine case, or together they form the position of the letter V. The crankshaft consists of two identical crank elements which are directed opposite each other along their common axis of rotation, and they are connected with each other in a rotatable and contra-rotating way around said axis with the help of a distance bearing. Furthermore, the crankshaft has two shafts to transfer the drive, which are projected from its both sides. The coupling function of the crankshaft is accomplished with the use of two identical pairs of connecting rods, while each connecting rod is connected in a rotatable way by its one end with one of contra-rotating crank elements. The other ends of said pair of connecting rods are connected in an oscillating way with one of two transverse shafts, while each of them is rigidly connected with one piston from the pair of coupled pistons through a push rod that is perpendicular thereto. In the middle of the wall of each cylinder, whose inner surface is covered with diamond coating, there is an inlet channel of scavenging air as well as an outlet channel of combustion products together with scavenging air. In the head of each cylinder and in its bottom partition there is a fuel injector, a steam injector and an ignition element. In the middle of each bottom partition a linear slide bearing of the partition is embedded, through which a push rod is led. The slide bearing of the partition is fitted from below with an annular sealing element, above which on the remaining length of the slide bearing, between its wall and the surface of the push rod, there is a micro lubricating aperture. Fuel injectors assigned to each cylinder are connected with a device for dosing steam through their steam lines, whereas said device is powered from a steam generator mounted on an exhaust pipe of a corresponding cylinder. Furthermore, there is a thermocouple mounted on each particular exhaust pipe, whereas in the light of passage there is a generator turbine and a turbine of a supportive fan. The supportive fan supplies scavenging air to the inlet channel of compressed air of said cylinder through the main fan assigned to an opposite cylinder. Electrical exits of all generators are connected in parallel with electrical exits of all thermocouples, and they are supplied to an accumulator which powers a HHO generator. An oxygen gas line from the HHO generator is led to an ultraviolet ionizer, from where it further goes to one of entries of a three-way gas connector, to whose other entry a hydrogen gas connector is carried from the HHO generator. The exit of the gas connector is connected through a compressor in parallel with entries of all individual fuel dosing devices, whose exits are connected with all fuel injectors assigned to them.

Furthermore, the propulsion system of aerial drones developed by German company Airstier comprises four individual combustion engines used to drive four propellers of a drone as well as four supporting electrical engines coupled thereto, which facilitate increasing the stability and maneuverability in air.

The internal combustion engine powered by hydrogen fuel, known from the patent description U.S. Pat. No. 6,918,382, is used to power a scooter with a controlled amount of injected hydrogen. The system of controlling the amount of hydrogen fuel causes an injection of fuel into an engine throttle, taking into account multiple parameters, including the amount of hydrogen located in the hydrogen storage system, which is controlled with the help of the system for measuring hydrogen fuel with the use of a micro controller as well as many sensors which cooperate with it.

Furthermore, what is known is the method of producing and utilizing hydrogen fuel with the use of the HHO generator, in which after supplying energy from an alternator, the electrolysis of water derived from a car tank occurs. As a consequence of this process, a non-explosive mixture of hydrogen and oxygen emerges. Said mixture is directly supplied to the fuel system of the engine together with sucked air and standard motor fuel. The known method enables reducing the usage of standard fuel in an internal combustion engine, but it does not eliminate it.

A distinctive feature of the combustion process in a chamber of a cylinder of the known engine powered by a hydrogen mixture is detonation combustion of hydrogen at the temperature of up to 7000° C. in the combustion chamber of the cylinder. These phenomena have an adverse impact on durability of engine elements, in particular enduringness and stability of parameters of its moveable parts, especially pistons. The indicated problem is solved in the below description of the hybrid propulsion system and methods connected thereto according to the present invention.

The hybrid propulsion system according to the present invention comprises one-stroke contra-rotating engine especially for hydrogen fuel, which has a pair of double reciprocating pistons, which are situated in two-chamber cylinders directed opposite each other and secured to an engine case. From the outer part the cylinders are closed by a head, whereas in the spot where they are secured to the engine case, they are closed by a partition with a linear slide bearing of the partition located therein, through which a push rod is led to the engine case. Each piston consists of a top piston half and a bottom piston half which is separated from the top part by a compensation spring. The top piston half and the bottom piston half are situated in a slideable way on the push rod through a top slide bearing of the piston and a bottom slide bearing of the piston embedded therein. Furthermore, there is a top limiter and a bottom limiter situated on the push rod in an immobile way, and they are adjusted to outer surfaces of the top piston half and the bottom piston half. There are inlet channels in the middle of walls of cylinders, to which scavenging air is supplied from the exit of fans as well as outlet channels, which serve to carry out scavenging air together with combustion products through exhaust pipes. In the head of each cylinder as well as in its partition there is a fuel injector, a steam injector and an ignition element. Pistons that are placed in each pair of cylinders are coupled together with the help of a bipartite crankshaft situated in the engine case. The crankshaft consists of the first half of the crankshaft and the second half of the crankshaft, which are situated opposite each other along their common axis of rotation, and they are connected with each other in a rotatable and contra-rotating way around said axis with the help of a distance bearing. The coupling function of the crankshaft in respect to each pair of pistons is accomplished with the use of two identical pairs of connecting rods, which consist of the first connecting rod and the second connecting rod. The first connecting rod and the second connecting rod of one pair are eccentrically connected by their one ends with the first half of the crankshaft and the second half of the crankshaft, respectively. The other ends of this pair of connecting rods are connected in an oscillating way with one of two transverse shafts, while each of them is rigidly connected through the push rod perpendicular thereto with one of two pistons, which are placed in opposite cylinders of a given pair. The first exit shaft and the second exit shaft are projected from the first half of the crankshaft and the second half of the crankshaft, and they are connected with the first impeller system and the second impeller system through the first clutch and the second clutch, respectively.

In the first embodiment of the present invention, the first impeller system and the same second impeller system constitute individual and preferably multi-blade impellers, which are fastened on corresponding receptive shafts of the first clutch and the second clutch.

In another embodiment of the present invention, the first impeller system and the same second impeller system constitute two pair of preferably multi-blade impellers. Drive shafts of said impellers are connected with the first clutch and the second clutch embedded on receptive shafts through the first transmission belt and the second transmission belt, respectively.

The ends of blades of each impeller are fastened in a wheel rim of a rotor, which is placed eccentrically in a wheel rim of a stator, while maintaining the minimal distance between them, which enables a free rotational movement of the rotor rim. In each rotor rim magnetic dipoles in the form of neodymium magnet are evenly places along its circumference, whereas in the rim of each stator induction coils are evenly placed along its circumference. All induction coils of each stator rim are accordingly connected with their individual commutation systems, whereas said commutation systems are connected with the common system of collecting and transferring electrical energy, while commutation systems and the system of collecting and transferring electrical energy are connected with the control system. Altogether, it creates the system of electrical machines connected with impellers and, depending on a need, it plays a role of additional drive engines of impellers or generators to store the reserve of energy in the course of a flight.

The method of protecting a piston of the engine according to the present invention is concerned with achieving partial motorization of a rapid growth of pressure on the piston, as a result of an ignition of hydrogen mixture, by means of using the force of elasticity of a compensation spring, which is situated on a push rod between two halves of the piston as well as an effect of elasticity of an airbag created between said halves of the piston in the course of the piston movement in a closed zone of a cylinder, while at least one piston half can move towards the other piston half. Furthermore, in order to reduce the temperature of the piston in its particular positions in the course of the piston movement in the cylinder, scavenging of both piston halves occurs with the use of compressed air.

The method of obtaining a periodical torque of an impeller according to the present invention is concerned with partially transferring energy of a torque of the impeller through electromagnetic induction from impeller blades, fitted with magnetic dipoles, to electrical networks, coupled with said magnetic dipoles of static induction coils, which are placed around the rotational course of magnetic dipoles.

Electric current induced in circumferences of induction coils is supplied, following the commutation process, to the system of collecting and transferring electrical energy, and after that in the case of an insufficient torque on the impeller shaft, electrical energy from the system of collecting and transferring energy is directed back to induction coils, which affect rotating magnetic dipoles with the electrodynamic force, which causes a growth of the impeller torque.

The hybrid propulsion system with a hydrogen engine according to the present invention is designed for any land vehicles, surface and submarine ships, and in particular aircraft owing to a combined combustion and electrical system of driving these objects. Said system, used in helicopters, provides safety of a flight in case of a failure of an internal combustion engine. In such a case the propulsion function of an internal combustion engine is taken by the system of electrical machines, which works as electrical drive engines, for the time which enables safe landing. There is also a possibility of individually controlling the power of said electrical drive engines. It is the most significant advantage of the solution according to the present invention. Another advantage in this case is also a possibility of the optimum use of the drive as well as the reduction of the fuel usage.

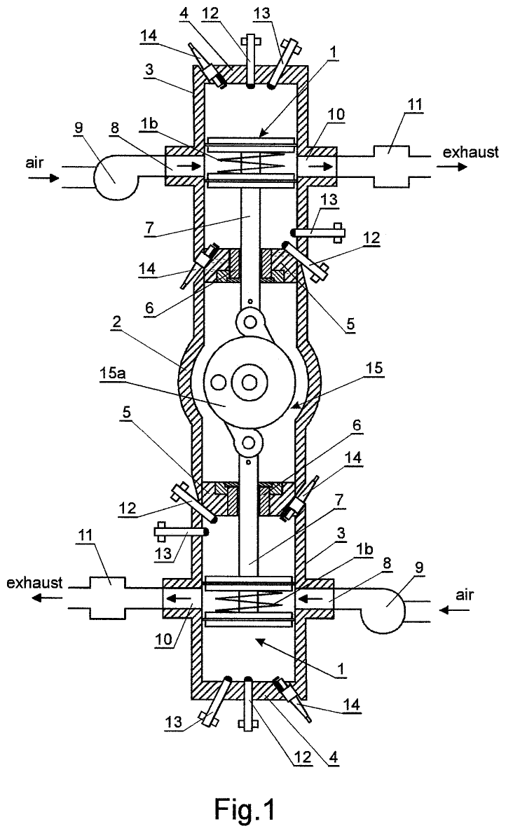

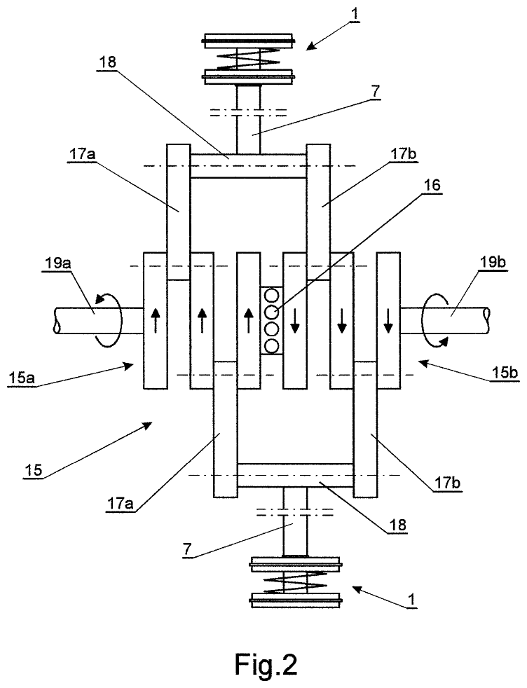

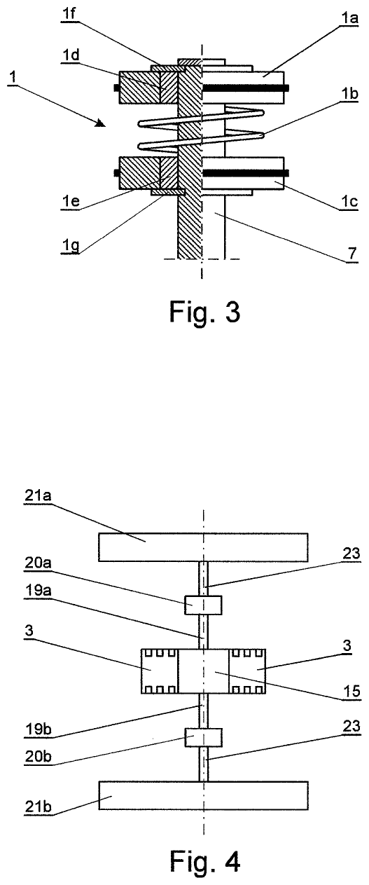

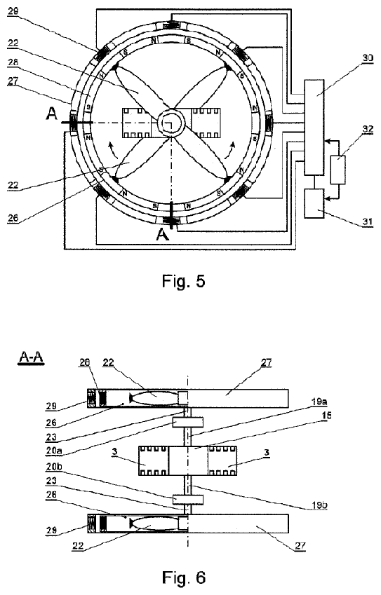

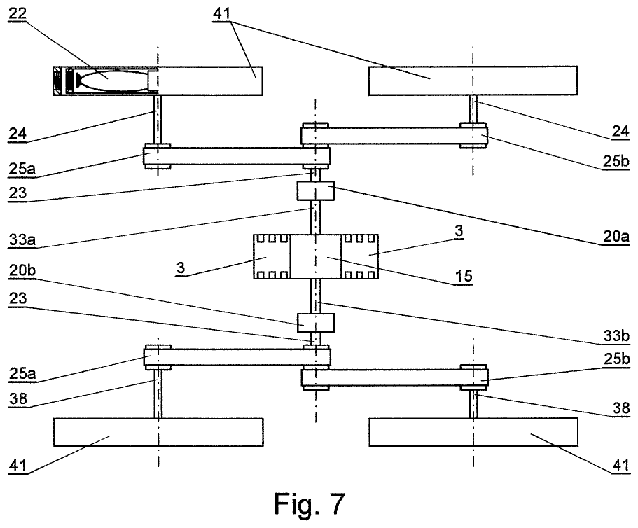

The present invention is shown on the example of embodiment in drawings, in which FIG. 1 shows a schematic diagram of the hydrogen engine, FIG. 2 is a visual representation of the crankshaft together with a pair of pistons, furthermore FIG. 3 shows the piston in half-section, FIG. 4 is a general conception of compression of the internal combustion engine with impeller systems, moreover FIG. 5 constitutes a schematic representation of the propulsion system according to the first embodiment in a top perspective of the impeller system in connection with control systems,. FIG. 6 is a schematic representation of the propulsion system according to the first embodiment in a lateral perspective of impeller systems, whereas FIG. 7 constitutes a schematic representation of the propulsion system according to the second embodiment in a lateral perspective of impeller systems.

The propulsion system comprises a one-stroke contra-rotating engine especially for hydrogen fuel, which has a pair of double reciprocating pistons 1, which are situated in two-chamber cylinders 3 directed opposite each other and secured to an engine case 2. The inner surface of cylinders 3 is covered with diamond coating.

Covering walls of cylinders with diamond coating is a known method of protecting them against high temperature which emerges during combustion of hydrogen fuel. From the outer part the cylinders 3 are closed by a head 4, whereas in the spot where they are secured to the engine case 2, they are closed by a partition 5 with a linear slide bearing of the partition 6 located therein, through which a push rod 7 is led to the engine case 2. Each piston 1 consists of a top piston half 1a and a bottom piston half 1c which is separated from the top part by a compensation spring 1b. The top piston half 1a and the bottom piston half 1c are situated in a slideable way on the push rod 7 through a top slide bearing of the piston 1d and a bottom slide bearing of the piston 1e embedded therein. Furthermore, there is a top limiter If and a bottom limiter 1g situated on the push rod 7 in an immobile way and they are adjusted to outer surfaces of the top piston half 1a and the bottom piston half 1c. There are inlet channels 8 in the middle of walls of cylinders 3, to which scavenging air is supplied from the exit of fans 9 as well as outlet channels 10, which serve to carry out scavenging air together with combustion products through exhaust pipes 11. In the head 4 of each cylinder 3 as well as in its partition 5 there is a fuel injector 12, a steam injector 13 and an ignition element 14. Pistons 1 that are placed in each pair of cylinders 3 are coupled together with the help of a bipartite crankshaft 15 situated in the engine case 2. The crankshaft 15 consists of the first half of the crankshaft 15a and the second half of the crankshaft 15b, which are situated opposite each other along their common axis of rotation, and they are connected with each other in a rotatable and contra-rotating way around said axis with the help of a distance bearing 16. The coupling function of the crankshaft 15 in respect to each pair of pistons 1 is accomplished with the use of two identical pairs of connecting rods, which consist of the first connecting rod 17a and the second connecting rod 17b. The first connecting rod 17a and the second connecting rod 17b of one pair are eccentrically connected by their one ends with the first half of the crankshaft 15a and the second half of the crankshaft 15b, respectively. The other ends of this pair of connecting rods 17a and 17b are connected in an oscillating way with one of two transverse shafts 18, while each of them is rigidly connected through the push rod 7 perpendicular thereto with one of two pistons 1, which are placed in opposite cylinders 3 of a given pair. The first exit shaft 19a and the second exit shaft 19b are projected from the first half of the crankshaft 15a and the second half of the crankshaft 15b and they are connected with the first impeller system 21a and the second impeller system 21b through the first clutch 20a and the second clutch 20b, respectively.

In the first embodiment the first impeller system 21a and the same second impeller system 21b constitute individual and preferably multi-blade impellers 22, which are fastened on corresponding receptive shafts 23 of the first clutch 20a and the second clutch 20b.

In another embodiment the first impeller system 22a and the same second impeller system 22b constitute two pair of multi-blade impellers 22. Drive shafts 24 of said impellers are connected with the first clutch 20a and the second clutch 20b embedded on receptive shafts 23 through the first transmission belt 25a and the second transmission belt 25b, respectively. The ends of blades of each impeller 22 are fastened in a wheel rim of a rotor 26, which is placed eccentrically in a wheel rim of a stator 27, while maintaining the minimal distance between them, which enables a free rotational movement of the rotor rim 26. In each rotor rim 26 magnetic dipoles 28 in the form of neodymium magnet are evenly places along its circumference, whereas in the rim of each stator 27 induction coils 29 are evenly placed along its circumference. All induction coils 29 of each stator rim are accordingly connected with their individual commutation systems 30, whereas said commutation systems are connected with the common system of collecting and transferring electrical energy 31, while commutation systems 30 and the system of collecting and transferring electrical energy 31 are connected with the control system 32. Altogether, it creates the system of electrical machines connected with impellers 22 and, depending on a need, it plays a role of additional drive engines of impellers 22 or generators to store the reserve of energy in the course of a flight.

The engine operation in its particular work phases is identical with regard to both opposite pistons, but their work cycles are moved in the phase by the 180° angle. Thus, it suffices to describe work of only one cylinder 3 with a corresponding piston 1 in connection with the remaining cooperating subsystems of the engine. Compressed hydrogen fuel is supplied with the help of the fuel injector 12 to the space of the cylinder 3 above the piston 1, which constitutes a top combustion chamber. In the TDC of the piston 1 an ignition of fuel from a spark of the spark plug occurs. At the time when the highest temperature of around 7000° C. is achieved in the top combustion chamber, an injection of steam with the help of the steam injector 13 occurs, which leads to cooling of the combustion chamber to around 3500° C., with the simultaneous division of steam into oxygen and hydrogen. The emergence of an additional portion of fuel, obtained in this way in the combustion chamber, causes its auto-ignition, derivative explosion and a rapid growth of pressure in the space of the cylinder 3 chamber. A forced stroke of the piston 1 towards the partition occurs, afterwards a sharp growth of pressure of combustion gases on the top piston half 1a is alleviated thanks to the force of elasticity of the compensation spring 1b, which is supported on the bottom piston half 1c that is blocked by the bottom limiter 1g, and additionally thanks to an airbag formed between the top piston half 1a and the bottom piston half 1c. The force affecting the bottom piston half 1c is transferred onto the push rod 7 through said limiter, which causes its movement towards the partition 5. At the time when the middle of the piston 1 is in the axis of the inlet channel 8 and the outlet channel 10, between the top piston half 1a and the bottom piston half 1c, the minimal distance is maintained, which is determined by the thickness of the squeezed compensation spring 1b. Then the free space inside the piston 1 is formed between its both halves, which enables cooling of the inner surfaces of the top piston half 1a and the bottom piston half 1c with the help of scavenging compressed air supplied to the inlet channel 8 from the fan 9. In the course of the further movement of the piston 1, the top combustion chamber of the cylinder 3 is connected with the inlet channel 8 and the outlet channel 10, and as a consequence said chamber is washed out of combustion products as well as the outer surface of the top piston half 1a and the cylinder 3 wall are cooled. Compressed air, which washes and scavenges chambers of the cylinder 3, is carried from the fan 9 attached to the inlet channel 8. Furthermore, in this work phase of the engine, fuel is supplied from the bottom fuel injector 12 into the space of the cylinder 3 below the piston 1, which constitutes the bottom combustion chamber. Fuel undergoes compression in the course of the further downward movement of the piston 1 towards the partition 5. When the piston 1 approaches close the TDC, an ignition of fuel from the bottom ignition plug occurs as well as the aforementioned process is repeated so that steam is supplied to the bottom combustion chamber with the help of the steam injector 13, then it is divided into oxygen and hydrogen as well as the combustion of fuel obtained in this way occurs and the upward stroke of the piston 1 towards the head 4. A rapid growth of pressure of combustion gases on the bottom piston half 1c is alleviated, similarly like in the case of the top piston half 1a thanks to the elasticity force of the compensation spring 1b, which is supported on the blocked top piston half 1a, and additionally thanks to an airbag formed between the top piston half 1a and the bottom piston half 1b. The force affecting the top piston half 1a is transferred through the top limiter if onto the push rod 7, which causes its movement towards the head 4. At the time when the piston 1 is in the axis of the inlet channel 8 and the outlet channel 10, similarly like in the case of the downward piston 1 movement, cooling of inner surfaces of the top piston half 1a and the bottom piston half 1c occurs with the help of compressed air supplied to the inlet channel 8. In the course of the further movement of the piston 1, the bottom combustion chamber of the cylinder 3 is connected with the inlet channel 8 and the outlet channel 10, and as a consequence said chamber is washed out of combustion products by a spurt of compressed air as well as the outer surface of the bottom piston half 1a and the wall of the cylinder 3 of the top combustion chamber are cooled. In this way the one whole work cycle is accomplished, during which a linear reciprocal stroke of the push rod 7 occurs. The bottom end of the push rod 7 is led inside the engine case 2 through the tight slide bearing of the partition 6 situated in the partition 5. The push rods 7, which are projected from a pair of opposite cylinders 3, through pairs of the first connecting rod 17a and the second connecting rod 17b that are connected to each other, cause a contra-rotating rotational movement of the first half of the crankshaft 15a and the second half of the crankshaft, which together form the crankshaft 15. This movement is transferred through contra-rotating and opposite the first exit shaft 19a and the second exit shaft 19b onto entries of the first clutch 20a and the second clutch 20b, which transfer contra-rotating drive to the first impeller system 21a and the second impeller system 21b.

In the first embodiment of the present invention the drive is directly transferred to individual multi-blade impellers 20, which are fastened on receptive shafts 23 of the first clutch 20a and the second clutch 20b.

In another embodiment the drive is transferred to two pairs of multi-blade impellers 22 through drive shafts 24 of these impellers and with the help of the first transmission belt 25a and the second transmission belt 25b. The use of multi-blade impellers 22 stems from the necessity of coupling with the rotor rim 26 in multiple spots, which aims at stiffening the whole construction of the rotor.

Blades of each impeller 22, which are set into motion, rotate together with the rotor rim 26, which is mounted on their edges, and which comprises a string of identically directed magnetic dipoles 28, and they affect induction coils 29, situated in the stator rim 29, by their magnetic field. The system of electrical machines formed in this way can, depending on a need, generate electric current, which is transferred to the system of collecting and transferring energy 31 through the commutation system 30, and charge batteries of supporting accumulators, not shown in the drawing, or it can constitute the system of electric motors, supporting the internal combustion propulsion, which takes advantage of collected electrical energy, including the start-up system for the internal combustion engine. The presented support of the internal combustion propulsion with the use of the system of electrical machines connected with impellers 22 facilitates safe and mild landing of a helicopter thanks to the additional electrical propulsion of impellers 22 in case of a failure of the main combustion propulsion of a helicopter, in which the invention is incorporated. The mutual connection, of the combustion propulsion and the electrical propulsion connected with impellers 22 makes it possible to exchange energy between said propulsion systems and to optimize the fuel usage.

1. A hybrid propulsion system with an engine especially for hydrogen fuel comprising one-stroke contra-rotating internal combustion engine coupled with supporting electrical machines, and a pair of double reciprocating pistons, which are situated in two-chamber cylinders, whose inner space is covered with diamond coating, directed opposite each other and secured to an engine case, while from the outer part the cylinders are closed by a head, whereas in the spot, where they are secured to the engine case, they are closed by a partition with a linear slide bearing of the partition located in the middle, through which a push rod is led to the engine case, moreover in the middle of cylinders walls there are inlet channel of scavenging air connected with fans, and outlet channels of combustion products together with scavenging air connected with the exhaust systems, whereas in the head of each cylinder as well as in its bottom partition there is a fuel injector, a steam injector and an ignition element, furthermore pistons placed in each pair of cylinders are coupled together with the help of a bipartite crankshaft situated in the engine case, characterized in that, each piston (1) consists of a top piston half (1a) and a bottom piston half (1c) which is separated from the top part by a compensation spring (1b), while the top piston half (1a) and the bottom piston half (1b) are situated in a slideable way on the push rod (7) through a top slide bearing of the piston (1d) and a bottom slide bearing of the piston (1e) embedded on them, moreover there is a top limiter (1f) and a bottom limiter (1g) situated on the push rod (7) in an immobile way, and said limiters are adjusted to outer surfaces of the top piston half (1a) and the bottom piston half (1g).

2. The system according to claim 1, characterized in that, the first exit shaft (19a) and the second exit shaft (19b), which are projected from the bipartite crankshaft (15), are connected with the first impeller system (21a) and the second impeller system (21b) through the first clutch (20a) and the second clutch (20b), respectively.

3. The system according to claim 2, characterized in that, the first impeller system (21a) and preferably the same second impeller system (21b) constitute individual and preferably multi-blade impellers (22), which are fastened on receptive shafts (23) of the first clutch (20a) and the second clutch (20b), respectively.

4. The system according to claim 2, characterized in that, the first impeller system (22a) and preferably the same second impeller system (22b) constitute at least two pairs of preferably multi-blade impellers (22), whose drive shafts (24) are connected two intermediary elements of the propulsion system embedded on respective shafts (23) of the first clutch (20a) and the second clutch (20b) preferably through the first transmission belt (25a) and the second transmission belt (25b).

5. The system according to claim 3 or 4, characterized in that, ends of blades of each impeller (22) are fastened in a wheel rotor rim (26), which is placed eccentrically in a wheel stator rim (27), while maintaining the minimal distance between them, which enables a free rotational movement of the rotor rim (26), while in each rotor rim (26) magnetic dipoles (28) preferably in the form of neodymium magnet are evenly placed along its circumference, whereas in each stator rim (27) induction coils (29) are evenly placed along its circumference, which altogether creates the system of electrical machines connected with impellers (22), moreover all induction coils (29) of one stator rim (27) are accordingly connected with their individual commutation systems (30), whereas said commutation systems are preferably connected with the common system of collecting and transferring electrical energy (31), while commutation systems (30) and the system of collecting and transferring electrical energy (31) are connected with the control system (32).

6. A method of protecting a piston of a hydrogen engine against effects of detonation combustion, characterized in that, in order to achieve partial motorization of a rapid growth of pressure on the piston, as a result of an ignition of a hydrogen mixture, there is a possibility of using the force of elasticity of a compensation spring, which is situated on a push rod between two halves of the piston as well as an effect of elasticity of an airbag created between said halves of the piston in the course of the piston movement in closed zones of a cylinder, while at least one piston half can move towards the other piston half, furthermore in order to reduce the temperature of the piston in its particular positions in the course of the piston movement in the cylinder, scavenging of both piston halves occurs with the use of a spurt of compressed air.

7. A method of obtaining an additional periodical torque on an impeller shaft especially of helicopters powered by a hydrogen engine, characterized in that, some part of energy of an impeller torque is transferred through electromagnetic induction from ends of impeller blades, fitted with magnetic dipoles, to electrical networks, which are placed around the rotational course of magnetic dipoles, and electric current induced in circumferences of induction coils is supplied, following the commutation process, to the system of collecting and transferring electrical energy, and after that in the case of an insufficient torque on the impeller shaft, electrical energy from the system of collecting and transferring energy is directed back to induction coils, which affect rotating magnetic dipoles with the electrodynamic force, which causes a growth of the impeller torque.
